(19) United States
(12) Patent Application Publication
(10) Pub. No.: US 2010/0083813 A1
(43) Pub. Date: Apr. 8, 2010

(54) Guitar transposer pedal

(76) Inventor: Richard Remillard, Bakersfield, CA (US)

Correspondence Address: Charlette M. Cnssman, 802 Rockville Drive, Bakersfield, CA, 93312, US

(21) Appl. No.: 12/587,431

(22) Filed: Oct. 6, 2009

Related U.S. Application Data
(60) Provisional application No. 61/102,934, filed on Oct. 6, 2008.

(51) Int. Cl. G10H 1/44

(52) U.S. Cl. 84/454

(57) ABSTRACT

A guitar transposer comprises a sound input connected to a microchip that receives the input from the sound input and modifies the input sound, a sound output that transmits the modified sound back to the guitar, a power supply is connected to the microchip and provides an electrical circuit. There is an on and off means connected to the microchip and the power supply, and the on-off switch completes and breaks the electrical circuit. A visual indicator connected to the microchip and the power supply displays a visual indication of the chord corresponding to the modified sound. A user activated chord selection means is connected to the microchip.

### CROSS-REFERENCE TO RELATED APPLICATION

U.S. Provisional Application No. 61/102,934 for this invention was filed on Oct. 6, 2008 for which the inventor claims domestic priority.

### BACKGROUND OF THE INVENTION

The disclosed device relates generally to music, and changes to musical chords. More particularly, this invention pertains to a means for electronically changing the played chord for guitars, and a means to tune the guitar electronically.

### SUMMARY OF THE INVENTION

The disclosed device comprises an apparatus for the translation of musical chords from one key to another key based upon the input from the guitar or stringed instrument. The device then outputs the changed sound to the guitar where the changed chord is audible. The device thus operates as a capo, but does not require placement of an object against the strings of the instrument. The guitar player will connect the guitar to the device using the input and output ports. The device can be electronically powered either by a nine-volt battery or through a transformer. The device transposes a chord input from the guitar and outputs the chord in the chosen chord to the guitar.

The user determines the preferred chord for the song and either raises the chord output from the guitar by increasing the output chord signal to the guitar or decreases the chord output from the guitar by decreasing the output chord signal to the guitar. The device may also be used to tune the guitar. An alternative embodiment accomplishes the tuning through a simultaneous pressing of both the chord increase and chord decrease buttons.

The guitar transposer comprises a sound input connected to a microchip that receives the input from the sound input and modifies the input sound, a sound output that transmits the modified sound back to the guitar, a power supply is connected to the microchip and provides an electrical circuit. There is an on and off means connected to the microchip and the power supply, and the on-off switch completes and breaks the electrical circuit. A visual indicator connected to the microchip and the power supply displays a visual indication of the chord corresponding to the modified sound. A user activated chord selection means is connected to the microchip.

### BRIEF DESCRIPTION OF THE DRAWINGS

FIG. 1 is a front view of an embodiment of the disclosed device.

FIG. 2 is a schematic of the electrical system of the disclosed device.

FIG. 3 is a schematic of a digital LED readout that is suitable for use in the device.

FIG. 4 is a top view of an alternate embodiment of the disclosed device.

FIG. 5 is a schematic of an integrator that may be used in the disclosed device.

### DETAILED DESCRIPTION

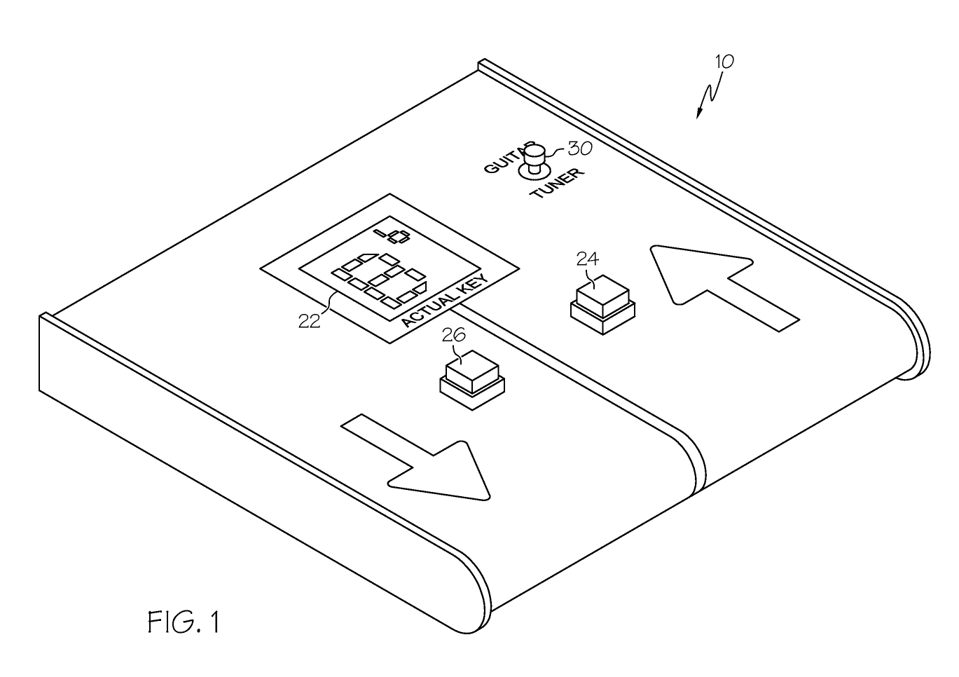

The guitar transposer 10 comprises a sound input 12 connected to a microchip 14 that receives the input from the sound input 12 and modifies the input sound, a sound output 16 that transmits the modified sound back to the guitar, which is not shown, a power supply 18 is connected to the microchip 14 and provides an electrical circuit. There is an on and off 20 means connected to the microchip 14 and the power supply 18, and the on-off switch 20 completes and breaks the electrical circuit. A visual indicator 22 is connected to the microchip 14 and the power supply 18 displays a visual indication of the chord corresponding to the modified sound. A user activated chord selection means is connected to the microchip 14, and the user activated chord selection means is shown as a first button 24 and a second button 26. FIG. 1 is a front view of the disclosed guitar transposer 10 placed within a pedal housing, and shows the enclosure of the housing 28. This is an optional placement, and the device need not be placed in such a manner. The up chord transpose button 24, the down chord transpose button 26, the guitar tuner button 30 and the visual indicator 22 screen displaying the chord that will be output by the guitar.

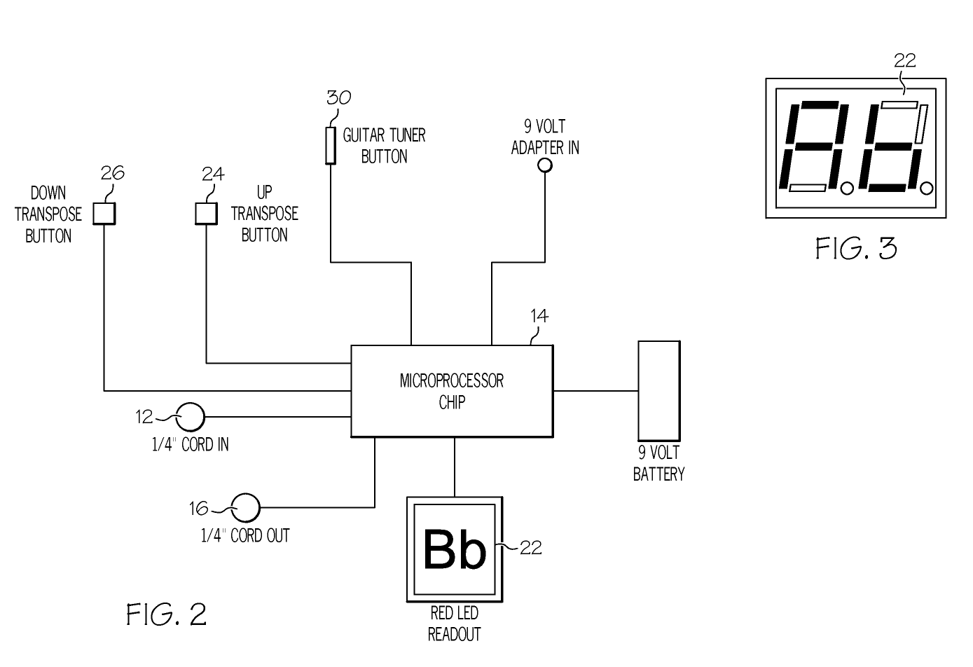

FIG. 2 is a schematic of the electrical system of the disclosed device. The guitar input 12 and output ports 16 are standard sized ports that will accommodate the majority of commercial guitars marketed today. The up chord transpose button 24, the down chord transpose button 26, the visual indicator screen 22, the guitar input 12 and output ports 16, the guitar tuner button 30 as well as the 9 volt adapter in and the 9 volt battery are connected to the microprocessor chip or integrator, and transmit information in the form of electrical signals to and receive information in the form of electrical signals from the microprocessor chip.

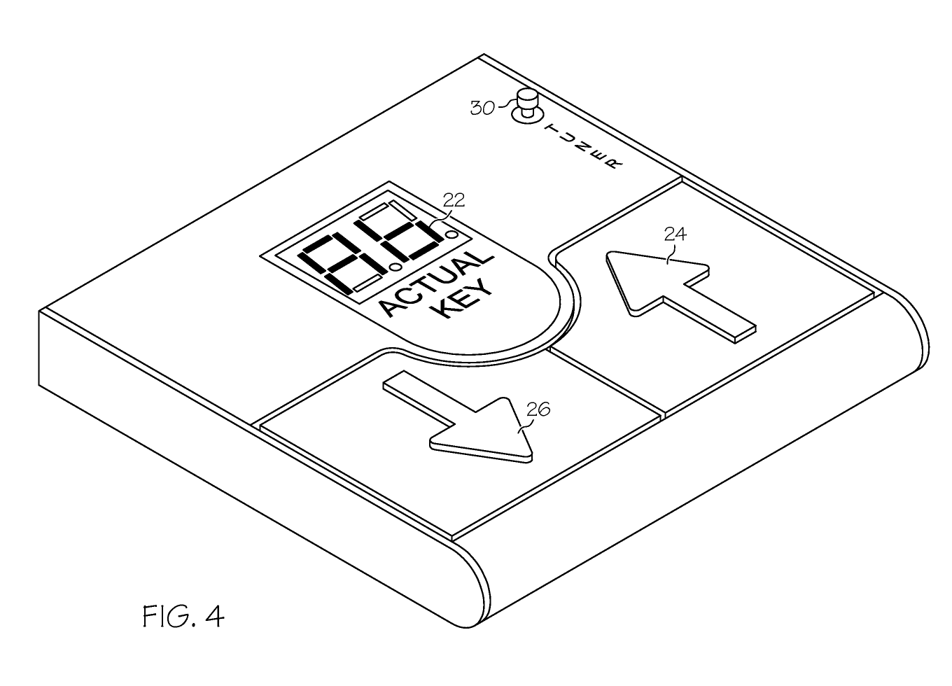

FIG. 3 is a schematic of a digital visual indicator 22 readout that is suitable for use in an embodiment of the device. The visual indicator 22 or similar display is capable of displaying two alphanumeric indications, and is a graphical representation of the chord the device will output to the guitar.

FIG. 4 is an alternate embodiment of the disclosed device, and has a visual indicator 22 or similar screen to display the actual key that is being output by the device to the guitar. The enclosure, the up chord transpose button 24, the down chord transpose button 26, and the guitar tuner button are shown on the enclosure. The device uses the electrical schematic of FIG. 2 and the visual indicator 22 or similar screen, of FIG. 3.

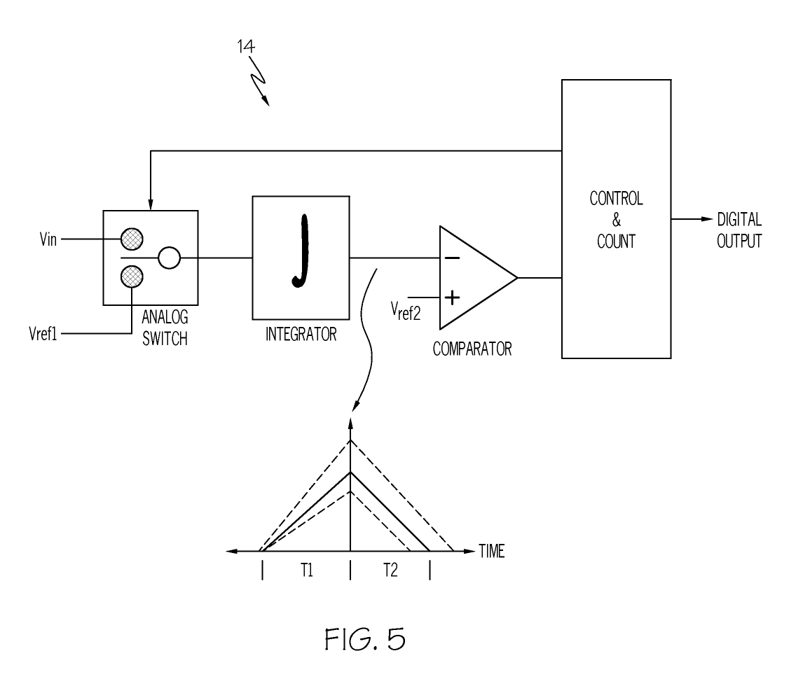

FIG. 5 is a schematic of a microprocessor chip 14 or integrator that may be used in an embodiment of the disclosed device. The integrator input is switched to a reference voltage, Vref1, where it is allowed to integrate down while a digital counter is incrementing. The counter is stopped when the integrator's output reaches a preset voltage, Vref2 (T2 period). The contents of the counter then represent the converted digital value. FIG. 5 shows the basic building blocks of a dual-slope integrating converter. The use of the dual-slope integrating converter has several important advantages. Because of the complementary nature of the two opposing slopes, the conversion accuracy is independent of the accuracies of both the clock frequency and the integrator capacitor. Also, due to the inherent nature of the built in integrator, the output digital value represents an averaging of the analog input signal over the integration period. This makes the converter highly immune to input noise.

The disclosed device comprises a guitar transposer 10 comprising, a microprocessor or microchip 14, a power supply 18 such as a nine volt battery providing power to the chip, or alternatively a nine volt adapter with transformer for providing an alternate source of power to the microprocessor 14, a visual indicator 22 readout to display the readings output by the microprocessor 14, a guitar input 12 for inputting sound to the microchip 14, a guitar output 16 for outputting sounds modified by the microprocessor to the guitar, an up chord transpose button 24 linked to the microchip 14 that initiates the conversion of the input sound to the next higher key, a down chord transpose button 26 linked to the microprocessor that initiates the conversion of the input sound to the next lower key, and a guitar tuner button 30 that initiates the tuning sequence of the guitar. The device may also be placed integrally to an in-line guitar cord, built within an amplifier, a PA system or a guitar pickup or the guitar itself, placed in a rack mount, placed upon the guitar or mounted using a clipping system.

While the above is a description of various embodiments of the present invention, further modifications may be employed without departing from the spirit and scope of the present invention. Thus the scope of the invention should not be limited according to these factors, but according to the appended claims.

I claim:

1. A guitar transposer comprising:
a sound input;
a microchip receiving the input from the sound input and modifying the input;
a sound output transmitting the modified sound;
a power supply connected to the microchip and proving an electrical circuit;
an on and off means connected to the microchip and the power supply;
a visual indicator connected to the microchip and the power supply, the visual indicator displaying a visual indication of the chord corresponding to the modified sound; and
a user activated chord selection means connected to the microchip.

2. The guitar transposer of claim 1 wherein the power supply is a nine-volt battery.

3. The guitar transposer of claim 1 wherein the power supply is a 120 volt transformer.

4. The guitar transposer of claim 1 wherein the on and off means is a button that when depressed alternately completes and breaks that electrical circuit.

5. The guitar transposer of claim 1 wherein the on and off means is a rocker switch wherein in on position the electrical circuit is complete and in the opposite position the electrical circuit is broken.

6. The guitar transposer of claim 1 wherein the user activated chord selection means is a first button that increases the chord of the desired sound output and a second button that decreases the chord of the desired sound output.

7. The guitar transposer of claim 1 further comprising a tuner means.
